(19) United States
(12) Patent Application Publication
(10) Pub. No.: US 2007/0181392 A1
(43) Pub. Date: Aug. 9, 2007

(54) GAS STRUT PROTECTIVE COVER

(75) Inventors: Jamie B. Pawloski, Canton, MI (US); Clark W. Young, Ann Arbor, MI (US); Faye R. Zaski, Dexter, MI (US)

Correspondence Address: GIFFORD, KRASS, SPRINKLE,;ANDERSON & CITKOWSKI, P.C., P.O. BOX 7021, TROY, MI, 48007-7021, US

(73) Assignee: Toyota Engineering & Manufacturing North America, Inc., Erlanger, KY (US)

(21) Appl. No.: 11/552,189

(22) Filed: Oct. 24, 2006

Related U.S. Application Data
(60) Provisional application No. 60/765,939, filed on Feb. 7, 2006.

(51) Int. Cl. F16F 9/38

(52) U.S. Cl. 188/322.12

(57) ABSTRACT

An improved protective cover is provided for a piston-cylinder unit. The cover has an elongated body with a convoluted portion and a cylindrical portion. The convoluted portion covers the piston rod of the piston-cylinder unit and allows the protective cover to contract and extend when said unit moves from a compressed position to an extended position. The cover is fixedly attached to the piston-cylinder unit such that it covers and protects the cylinder and the piston rod of the unit. The attachment of the protective cover to the piston-cylinder unit results in water and air resistant seals between the cover and the unit, or in the alternative, in non-watertight and/or non-airtight seals that prevent dirt, debris, dust and the like from contacting the cylinder and piston rod of the unit.

### RELATED APPLICATION

This application claims priority of U.S. Provisional Patent Application Ser. No. 60/765,939 filed Feb. 7, 2006, which is incorporated herein by reference.

### FIELD OF THE INVENTION

The present invention in general relates to a protective cover and in particular to a protective cover for a gas strut.

### BACKGROUND OF THE INVENTION

Gas struts are used in vehicles to assist in the closing of tailgates, hoods, trunk lids and the like. When used in conjunction with a truck tailgate, the gas strut is fully extended when the tailgate is in the closed or neutral state. As the tailgate opens, the gas strut compresses and slowly lowers the tailgate avoiding a slam open. Upon closing the tailgate, the gas strut provides a system for lifting the mass of the tailgate and thus reduces the closing effort. With the gas strut extended in a neutral condition, the rod of the strut is exposed to debris and should be protected to prevent damage to the seals of the strut when the rod is compressed into the strut.

### BRIEF SUMMARY OF THE INVENTION

An improved protective cover is provided for a piston-cylinder unit. The cover has an elongated body with a convoluted portion and a cylindrical portion. The convoluted portion covers the piston rod of the piston-cylinder unit and allows the protective cover to contract and extend when said unit moves between an extended position and a compressed position. The cover is fixedly attached to the piston-cylinder unit such that it covers and protects the cylinder and the piston rod of the unit. The attachment of the protective cover to each end of the piston-cylinder unit is accomplished with a cap and/or a lip and groove and results in water resistant an air resistant seals between the cover and the unit. In the alternative, non-watertight and/or non-airtight seals that prevent dirt, debris, dust and the like from contacting the cylinder and piston rod of the unit are used to attach the protective cover to the piston cylinder unit.

A fluid reservoir is created between the cylindrical portion of the protective cover and the cylinder of the unit. A space region is created between the convoluted portion of the protective cover and the piston rod of the unit. The fluid reservoir provides fluid to the space region when the piston-cylinder unit extends to an open position. Likewise, the fluid reservoir receives fluid from the space region when the piston-cylinder unit contracts to a closed position.

### BRIEF DESCRIPTION OF THE FIGURES

FIG. 1 shows a gas strut protective cover attached to a gas strut;

FIG. 2 shows a cross-sectional view of a compression fit cap type attachment;

FIG. 3 shows a cross-sectional view of a cap, lip and groove compression fit cap type attachment; and

FIG. 4 shows a cross-sectional view of a lip and groove type attachment.

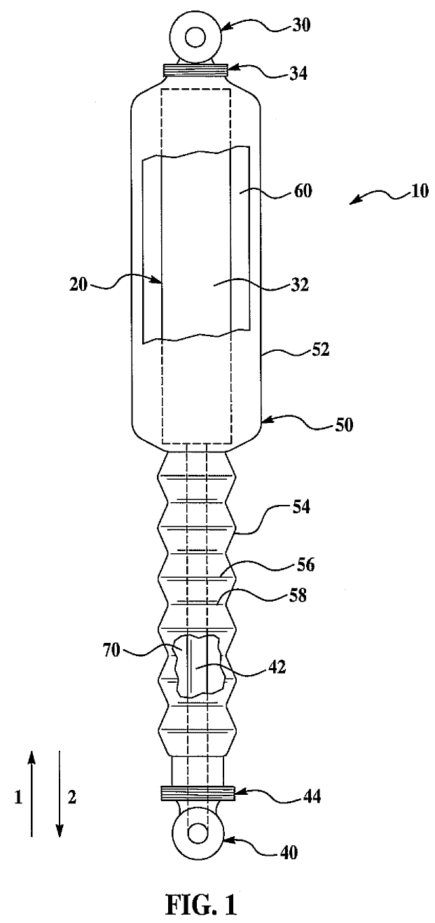

### DETAILED DESCRIPTION OF THE INVENTION

In accordance with the invention, gas strut protective cover 10 is attached to piston-cylinder unit 20. Piston-cylinder unit 20 has a first end 30, a cylinder 32, second end 40 and piston-rod 42.

Protective cover 50 has a cylinder portion 52 and a convoluted portion 54. The cylinder portion 52 has a uniform diameter along the axial direction wherein a fluid reservoir 60 is created between cylinder 32 and the cylinder portion 52. In the alternative, cylinder portion 52 has a changing diameter along the axial direction. In addition, cylinder portion 52 can have ridges and other support structures along the outside or inside diameter of the cylinder portion 52 for the purpose of providing structural support. The protective cover 10 can be manufactured from a range of suitable materials known to those skilled in the art illustratively including polyvinyl chloride (PVC), thermoplastic olefins (TPO) and ethylene propylene diene (EPDM) rubber.

Convoluted portion 54 has a series of peaks 56 and valleys 58 affording for an accordion-like extension and contraction of the portion 54. In this manner, convoluted portion 54 of protective cover 50 contracts and extends when piston rod 42 moves in a first direction 1 and a second direction 2, respectively. The convoluted portion 54 creates a space region 70 between the piston rod 42 and the portion 54. The volume of space region 70 decreases when portion 54 contracts and increases when portion 54 extends.

A first end 34 of protective cover 50 fixedly attaches to the piston-cylinder unit 20 proximal to first end 30. Likewise, a second end 44 of protective cover 50 fixedly attaches to the piston-cylinder unit 20 proximal to the second end 40. The attachment of first end 34 and second end 44 afford water and air resistant seals around cylinder 32 and piston rod 42. In this manner, dirt, debris, dust and the like are prevented from contacting the cylinder 32 and piston rod 42 of the piston-cylinder unit 20. In the alternative, the attachment of first end 34 and second end 44 to the piston-cylinder unit do not afford watertight and airtight seals around cylinder 32 and piston rod 42, but is secured in such a manner to allow a slow flow of air into and out of the protective cover 50 and yet prevent dirt, debris, dust and the like from contacting the cylinder 32 and piston rod 42. The prevention of dirt, debris, dust and the like from contacting the cylinder 32 and piston rod 42 affords protection of any seals, gaskets and any other parts within or on said piston-cylinder unit 20.

When piston rod 42 extends in a second direction 2, fluid reservoir 60 provides fluid into space region 70, thereby affording normal operation of the piston-cylinder unit 20. Likewise, fluid within space 70 is allowed to pass into fluid reservoir 60 when piston rod 42 contracts in a first direction 1. Typically said fluid is air. In the alternative, said fluid is not air, illustratively including inert gases and non-corrosive liquids.

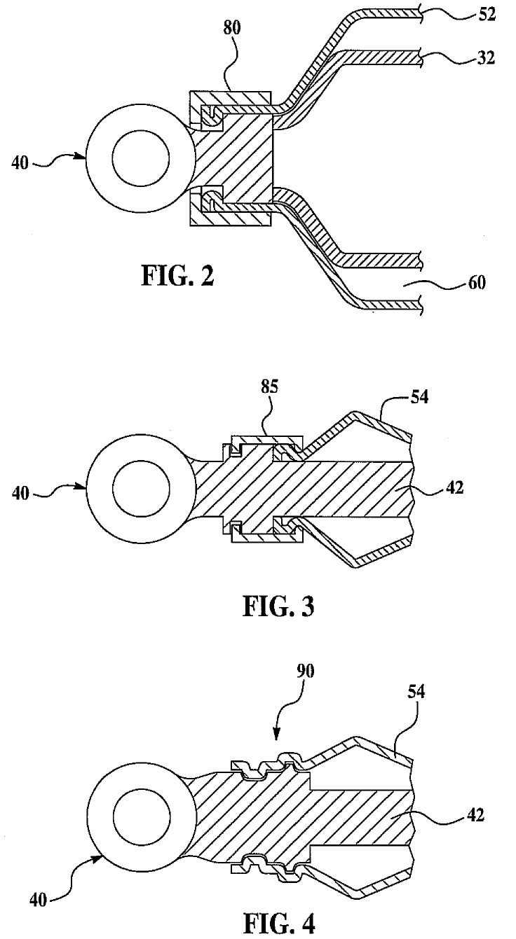

Attachment of first end 34 and second end 44 proximal to first end 30 and second end 40 is afforded by any means providing a water and air resistant seal, or in the alternative any means that allows a slow breathing of air into and out of the protective cover 50 and yet prevents dirt, debris, dust and the like from contacting the cylinder 32 and piston rod 42. For illustrative purposes only, this attachment can be afforded by using a compression fit type cap 80 (FIG. 2), a lip and groove compression fit type cap 85 (FIG. 3) and/or a lip and groove 90 (FIG. 3). A cap can be manufactured from any suitable material known to those skilled in the art, illustratively including plastics, metals and alloys. In this manner, water and air resistant seals, or in the alternative non-watertight and non-airtight seals, that prevent dirt, debris, dust and the like from contacting the cylinder 32 and piston rod 42, are provided and afford an improved protective cover for a gas strut. It is important to note that the protective cover disclosed in the present invention can be used to protect any type of piston-cylinder unit.

The invention is not restricted to the illustrative examples described above. The examples are not intended as limitations on the scope of the invention. Methods, apparatus, compositions, and the like described herein are exemplary and not intended as limitations on the scope of the invention. Changes therein and other uses will occur to those skilled in the art. The scope of the invention is defined by the scope of the claims.

1. An improved protective cover for a piston-cylinder unit, said unit having a piston rod movable between an extended position and a compressed position, wherein the cover comprises:
an elongated tubular body having a convoluted portion and a cylindrical portion, said convoluted portion extending in an axial direction for covering the piston rod;
said convoluted portion extending and contracting when the piston-rod unit extends and contracts;
said cylindrical portion having a uniform diameter along an axial direction of said elongated body for covering the cylinder and providing a fluid reservoir;
said first end of said body being fixedly attached to the first end of the piston-cylinder unit; and
said second end of said body being fixedly attached to the second end of the piston-cylinder unit for providing a protective cover for the entire length of the piston-cylinder unit.

2. The invention of claim 1, wherein said fluid reservoir is an air reservoir.

3. The invention of claim 1, wherein said first end of said cover is fixedly attached to the first end of the piston-cylinder unit with a cap.

4. The invention of claim 1, wherein said second end of said cover is fixedly attached to the second end of the piston-cylinder unit with cap.

5. The invention of claim 1, wherein said first end of said cover is fixedly attached to the first end of the piston-cylinder unit with a first end lip and groove.

6. The invention of claim 1, wherein said second end of said cover is fixedly attached to the second end of the piston-cylinder unit with a second end lip and groove.
